(19) United States
(12) Patent Application Publication
(10) Pub. No.: US 2004/0168206 A1
(43) Pub. Date: Aug. 26, 2004

(54) Device for interacting with real-time streams of content

(76) Inventor: Marcelle Andrea Stienstra, Eindhoven (NL)

Correspondence Address: Laurie E Gathman, U S Philips Corporation, Intellectual Property Department, PO Box 3001, Briarcliff Manor, NY, 10510, US

(21) Appl. No.: 10/477,496

(22) PCT Filed: May 14, 2002
(86) PCT No.: PCT/IB02/01663

(30) Foreign Application Priority Data
May 14, 2001 (EP) 01201797.6

(51) Int. Cl. H04N 7/173; H04N 7/16; H04N 7/00

(52) U.S. Cl. 725/139; 725/87; 725/86; 725/135; 348/461

(57) ABSTRACT

An end-user system (10) for transforming real-time streams of content into an output presentation includes an input device (30) that allows a user to interact with the streams in order to adapt the presentation. The input device (30) includes representation objects (340), each of which represents a specific stream of content, and a transmission object (300). In order to activate a particular stream of content, the user connects the corresponding representation object (340) to the transmission object (300). The user can deactivate the stream of content by removing the corresponding representation object (340) from the transmission object (300). The transmission object (300) determines which representation objects (340) have been connected to it, and indicates these connections to the end-user system (10), which activates and deactivates the streams, accordingly.

The present invention relates to a system and method for receiving and displaying real-time streams of content. Specifically, the present invention enables a user to interact with and personalize the displayed real-time streams of content.

Storytelling and other forms of narration has always been a popular form of entertainment and education. Among the earliest forms of these are oral narration, song, written communication, theater, and printed publications. As a result of the technological advancements of the nineteenth and twentieth century, stories can now be broadcast to large numbers of people at different locations. Broadcast media, such as radio and television, allow storytellers to express their ideas to audiences by transmitting a stream of content, or data, simultaneously to end-user devices that transforms the streams for audio and/or visual output.

Such broadcast media are limited in that they transmit a single stream of content to the end-user devices, and therefore convey a story that cannot deviate from its predetermined sequence. The users of these devices are merely spectators and are unable to have an effect on the outcome of the story. The only interaction that a user can have with the real-time streams of content broadcast over television or radio is switching between streams of content, i.e., by changing the channel. It would be advantageous to provide users with more interaction with the storytelling process, allowing them to be creative and help determine how the plot unfolds according to their preferences, and therefore make the experience more enjoyable.

At the present time, computers provide a medium for users to interact with real-time streams of content. Computer games, for example, have been created that allow users to control the actions of a character situated in a virtual environment, such as a cave or a castle. A player must control his/her character to interact with other characters, negotiate obstacles, and choose a path to take within the virtual environment. In on-line computer games, streams of real-time content are broadcast from a server to multiple personal computers over a network, such that multiple players can interact with the same characters, obstacles, and environment. While such computer games give users some freedom to determine how the story unfolds (i.e., what happens to the character), the story tends to be very repetitive and lacking dramatic value, since the character is required to repeat the same actions (e.g. shooting a gun), resulting in the same effects, for the majority of the game's duration.

Various types of children's educational software have also been developed that allows children to interact with a storytelling environment on a computer. For example, LivingBooks® has developed a type of “interactive book” that divides a story into several scenes, and after playing a short animated clip for each scene, allows a child to manipulate various elements in the scene (e.g., “point-and-click” with a mouse) to play short animations or gags. Other types of software provide children with tools to express their own feelings and emotions by creating their own stories. In addition to having entertainment value, interactive storytelling has proven to be a powerful tool for developing the language, social, and cognitive skills of young children.

However, one problem associated with such software is that children are usually required to using either a keyboard or a mouse in order to interact. Such input devices must be held in a particular way and require a certain amount of hand-eye coordination, and therefore may be very difficult for younger children to use. Furthermore, a very important part of the early cognitive development of children is dealing with their physical environment. An interface that encourages children to interact by “playing” is advantageous over the conventional keyboard and mouse interface, because it is more beneficial from an educational perspective, it is more intuitive and easy to use, and playing provides a greater motivation for children to participate in the learning process. Also, an interface that expands the play area (i.e., area in which children can interact), as well as allowing children to interact with objects they normally play with, can encourage more playful interaction.

ActiMates™ Barney™ is an interactive learning product created by Microsoft Corp.®, which consists of a small computer embedded in an animated plush doll. A more detailed description of this product is provided in the paper, E. Strommen, “When the Interface is a Talking Dinosaur: Learning Across Media with ActiMates Barney,” Proceedings of CHI '98, pages 288-295. Children interact with the toy by squeezing the doll's hand to play games, squeezing the doll's toe to hear songs, and covering the doll's eyes to play “peek-a-boo.” ActiMatesBarney can also receive radio signals from a personal computer and coach children while they play educational games offered by ActiMates software. While this particular product fosters interaction among children, the interaction involves nothing more than following instructions. The doll does not teach creativity or collaboration, which are very important in the developmental learning, because it does not allow the child to control any of the action.

CARESS (Creating Aesthetically Resonant Environments in Sound) is a project for designing tools that motivate children to develop creativity and communication skills by utilizing a computer interface that converts physical gestures into sound. The interface includes wearable sensors that detect muscular activity and are sensitive enough to detect intended movements. These sensors are particularly useful in allowing physically challenged children to express themselves and communicate with others, thereby motivating them to participate in the learning process. However, the CARESS project does not contemplate an interface that allows the user any type of interaction with streams of content.

It is an object of the present invention allow users to interact with real-time streams of content received at an end-user device. This object is achieved according to the invention in an input device as claimed in claim 1. Real-time streams of content are transformed into a presentation that is output to the user by an output device, such as a television or computer display. The presentation can convey a narrative whose plot unfolds according to the transformed real-time streams of content, and the user's interaction with these streams of content helps determine the outcome of the story by activating or deactivating streams of content, or by modifying the information transported in these streams. The input device allows users to interact with the real-time streams of content in a simple, direct, and intuitive manner. The input device provides users with physical, as well as mental, stimulation while interacting with real-time streams of content.

One embodiment of the present invention is directed to a system that transforms real-time streams of content into a presentation to be output and an input device that is manipulated by a user in order to activate or deactivate streams of content within the presentation. The input device includes one or more representation objects, each object representing a stream of content, and a transmission object to which a user connects the representation object(s) in order to activate the corresponding stream(s) of content in the presentation.

In another embodiment, the transmission object includes one or more object interfaces at which representation objects may be physically connected, and a microprocessor for detecting representation objects that have been connected to the interfaces. The microprocessor generates a signal, which identifies the detected representation objects, for transmission to the end-user device. The end-user device activates the streams of content corresponding to the identified representation objects.

In another embodiment of the present invention, the microprocessor detects one or more representation objects that have been removed from the transmission object. The microprocessor generates a signal identifying the removed representation objects for transmission to the end-user device, which deactivates streams of contents corresponding to the identified representation objects.

In another embodiment, each representation object includes an indicator, which is triggered when the corresponding stream of content becomes active while the representation object is connected to the transmission object.

In another embodiment, each representation object includes a visual or audible representation of the stream of content that it represents.

In another embodiment, a representation object must be connected to a designated object interface on the transmission object.

In another embodiment, a representation object may be connected to any object interface on the transmission object.

In another embodiment of the present invention, each object interface of the transmission object corresponds to a stream of content, and the microprocessor generates a signal identifying the interfaces that have representation objects connected to them. The signal is transmitted to the end-user device, which activates or deactivates streams of content corresponding to the identified interfaces.

Another embodiment of the present invention is directed to a method of transforming real-time streams of content into a presentation, in which a user activates and deactivates streams of content through the input device.

These and other embodiments of the present invention will become apparent from and elucidated with reference to the following detailed description considered in connection with the accompanying drawings.

It is to be understood that these drawings are designed for purposes of illustration only and not as a definition of the limits of the invention for which reference should be made to the appending claims.

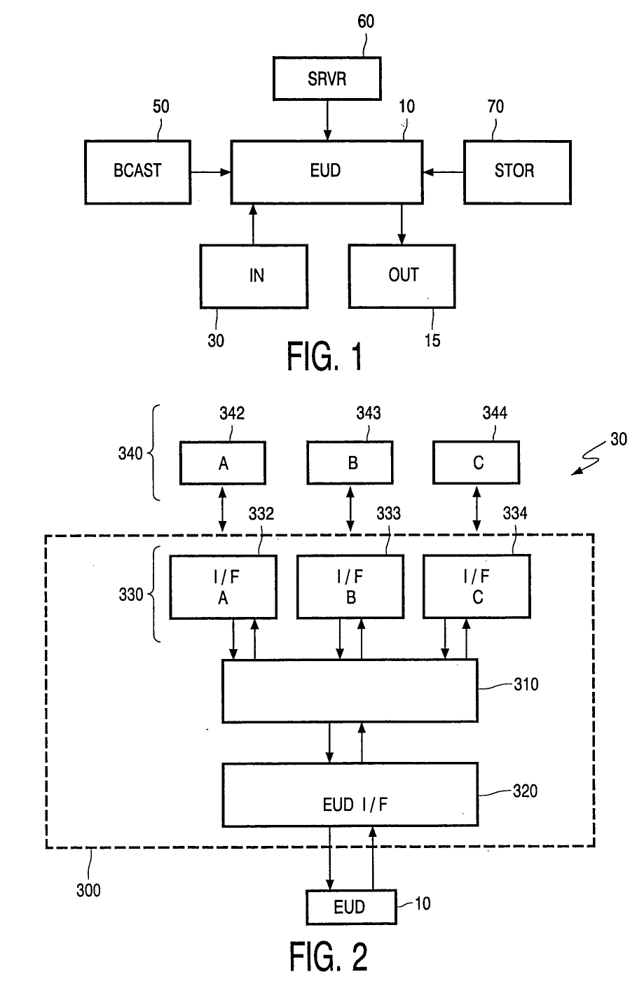

FIG. 1 is a block diagram illustrating the configuration of a system for transforming real-time streams of content into a presentation.

FIG. 2 is a block diagram illustrating the configuration of the input device according to an exemplary embodiment.

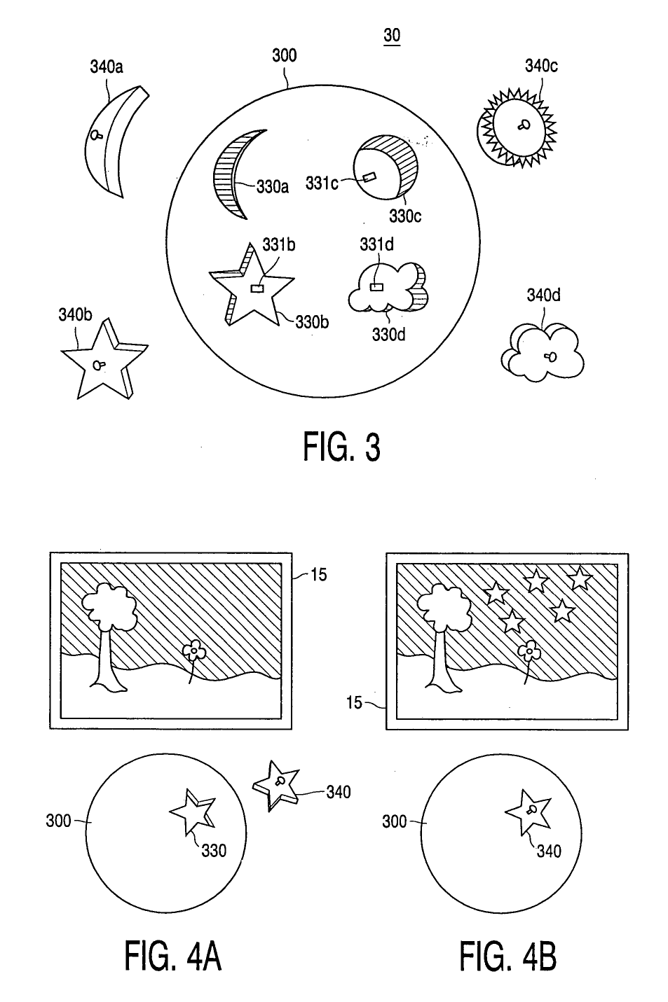

FIGS. 3 illustrates an embodiment where each representation object corresponds to a specific object interface of the transmission object.

FIGS. 4A and 4B illustrate the activating of a stream of content corresponding to the placement of a representation object on a transmission object.

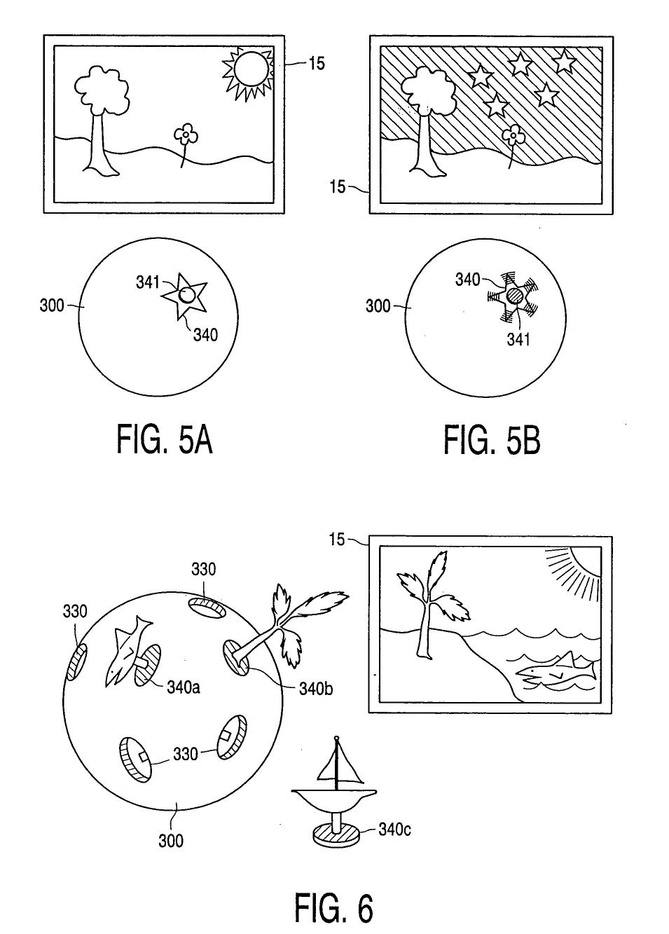

FIGS. 5A and 5B illustrate an indicator on a representation object being triggered when the corresponding stream of content becomes active in the presentation.

FIG. 6 illustrates an embodiment where a representation object can be placed in any object interface.

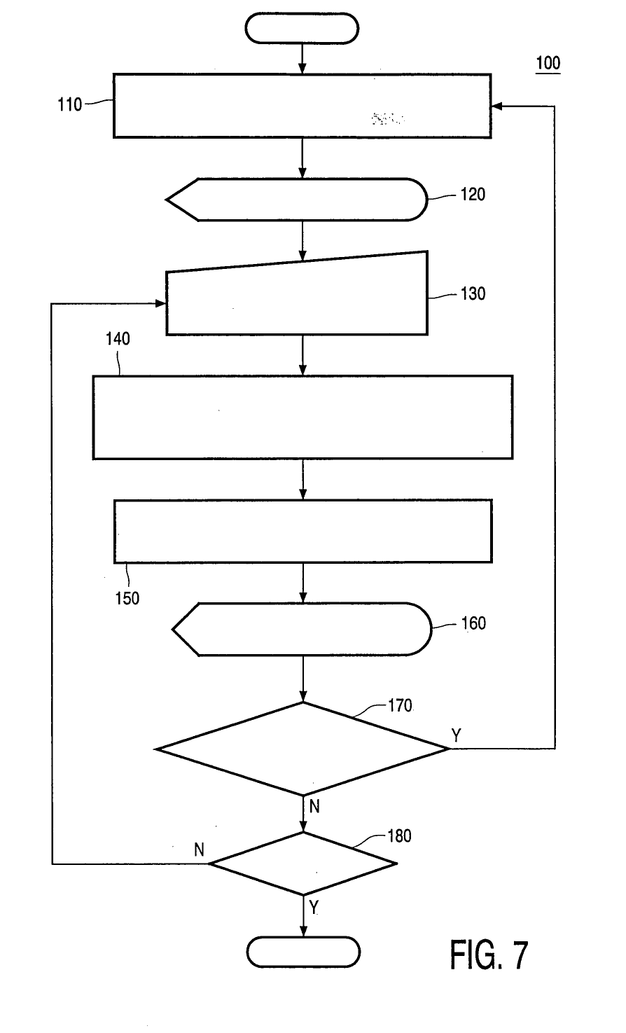

FIG. 7 is a flowchart illustrating the method whereby real-time streams of content can be transformed into a narrative.

Referring to the drawings, FIG. 1 shows a configuration of a system for transforming real-time streams of content into a presentation, according to an exemplary embodiment of the present invention. An end-user device 10 receives real-time streams of data, or content, and transforms the streams into a form that is suitable for output to a user on output device 15. The end-user device 10 can be configured as either hardware, software being executed on a microprocessor, or a combination of the two. One possible implementation of the end-user device 10 and output device 15 of the present invention is as a set-top box that decodes streams of data to be sent to a television set. The end-user device 10 can also be implemented in a personal computer system for decoding and processing data streams to be output on the CRT display and speakers of the computer. Many different configurations are possible, as is known to those of ordinary skill in the art.

The real-time streams of content can be data streams encoded according to a standard suitable for compressing and transmitting multimedia data, for example, one of the Moving Picture Experts Group (MPEG) series of standards. However, the real-time streams of content are not limited to any particular data format or encoding scheme. As shown in FIG. 1, the real-time streams of content can be transmitted to the end-user device over a wire or wireless network, from one of several different external sources, such as a television broadcast station 50 or a computer network server. Alternatively, the real-time streams of data can be retrieved from a data storage device 70, e.g. a CD-ROM, floppy-disc, or Digital Versatile Disc (DVD), which is connected to the end-user device.

As discussed above, the real-time streams of content are transformed into a presentation to be communicated to the user via output device 15. In an exemplary embodiment of the present invention, the presentation conveys a narrative to the user. Unlike prior art systems that merely convey a story whose plot is predetermined by the real-time streams of content, the present invention allows the user to interact with the narrative presentation and help determine its outcome by manipulating an input device 30. According to these manipulations, the user activates or deactivates streams of content associated with the presentation. For example, each stream of content may cause the story to follow a particular storyline, and the user determines how the plot unfolds by activating a particular stream, or storyline. Therefore, the present invention allows the user to exert creativity and personalize the story according to his/her own wishes. However, the present invention is not limited to transforming real-time streams of content into a story to be presented to the user. According to other exemplary embodiments of the present invention, the real-time streams can be used to convey songs, poems, musical compositions, games, virtual environments, adaptable images, or any other type of content with which the user can adapt according to his/her personal wishes.

As mentioned above, FIG. 2 shows in detail the input device 30, which includes representation objects 340 and a transmission object 300. The transmission object is a device that includes a plurality of object interfaces 330, each of which comprises a port to which a representation object 340 can be physically connected. In an exemplary embodiment as shown in FIG. 2, each object interface 330 is specifically configured to be connected with particular representation object 340, i.e., only object A 342 should be connected to object interface A 332. In another exemplary embodiment, each object interface is capable of receiving any representation object from a set of representation objects. While FIG. 2 only shows three different object interfaces A, B, and C (332, 333, and 334, respectively) corresponding to three different representation objects A, B, and C (342, 343, 344, respectively), it will be clear to one of ordinary skill in the art that this figure is exemplary and that the input device 30 may include any number of object interfaces 330 and representation objects that will suit the requirements of the output presentation.

In an exemplary embodiment, each object interface 330 supports data communication between the transmission object 300 and the connected representation object 340. In this embodiment, the representation object may transmit a signal to the transmission object 300 that identifies itself as a representation object 340, or as a particular type of representation object 340. However, in another exemplary embodiment, the object interface 330 may detect a representation object 340 being connected therewith, according to a sensor, e.g., a pressure sensor. In this alternative embodiment, the object interface 330 may comprise a hole having particular shape, into which only a representation object 340 having a similar shape may be inserted. In this embodiment, each object interface 330 will automatically be able to determine the type of representation object 340 to which it is connected.

Each object interface 330 transmits a signal to a microprocessor 310 in the transmission object, indicating that a representation object 340 has been connected. In an exemplary embodiment in which each representation object represents a stream of content, the object interface 330 formats and transmits identification data sent from the representation object 340 to the microprocessor 310.

However, in another exemplary embodiment, each object interface represents a stream of content. In this embodiment, each object interface 330 transmits a signal to the microprocessor 310 indicating that a representation object has been connected, without identifying the type of the representation object.

In the embodiment where each representation object 340 represents or corresponds to a stream of content, the microprocessor 310 receives the signals sent from the object interfaces 330 and determines which representation object 340 has been connected. The microprocessor generates a signal to be transmitted to the end-user device 15, identifying a representation object 340 that has been connected to an object interface 330. The microprocessor 310 may generate and transmit this signal immediately after it receives a signal from an object interface 330 indicating a connection to a representation object 340. Else, the microprocessor 310 may generate and transmit a signal at predetermined times (such as the beginning of a new scene in a narrative presentation), where the signal identifies the set of representation objects 340 currently connected to the transmission object 300.

In the alternate embodiment where each object interface 330 is associated with a particular stream of content, the microprocessor 310 determines generates a signal that identifies an object interface 330 that has been connected to a representation object 340. Similar to the previous embodiment, the microprocessor 310 may generate and transmit this signal immediately in response to a signal being received from the object interface 330; else, the microprocessor 310 may generate transmit a signal at predetermined times identifying the object interface 330 that currently have a connection with a representation object 340.

In an exemplary embodiment, the object interface 330 also transmits a signal to the microprocessor that indicates that a representation object 340 has been removed or disconnected. In response, the microprocessor 320 may generate a signal to be transmitted to the end-user device 10 identifying the representation object 340 or the object interface 330.

The signal generated by the microprocessor is sent to the end-user device interface 320, which formats the signal for transmission, and transmits the signal to the end-user device 10 via wires, radio signals, or any other type of communication link as will be contemplated by those of ordinary skill in the art. The end-user device 10 receives and decodes the transmitted signal, determines which stream of contents are associated with the identified representation objects 340 or object interfaces 330, and activates the determined streams in the presentation.

The end-user device 10 also determines which streams are associated with representation objects 340 identified as being disconnected from the transmission object 300, or object interfaces 330 that have been identified as losing its connection to a representation object 330. The end-user device 10 then deactivates these streams of content.

In an exemplary embodiment, the end-user device 10 determines which streams of content are associated with each representation object 340 or object interface 330 by examining control data, which is incorporated in the transmitted real-time streams of content. Conversely, the end-user device 10 may store this control data in a memory, or else, the control data may be transmitted to the end-user device from the microprocessor 320 of the transmission object 300.

FIGS. 3-6, described in detail below, illustrate embodiments of the present invention where the transmission object 300 takes the form of a ball having one or more object interfaces 330 into which representation objects 340 may be plugged. These figures are exemplary and are in no way limiting as to the form of the elements of the input device 30. For example, in other exemplary embodiments, the transmission object may be a flat board or mat, such as a game board, on top of which representation objects 340 in the form of game pieces are placed. Further, the transmission object 300 may simulate a setting, such as a castle or beach house, where representation objects 340 in the form of action figures or dolls may be inserted. The transmission object 300 and the representation objects 340 of the present invention may take on a wide variety of forms, as will be clear to those of ordinary skill in the art.

FIG. 3 further illustrates an example of an exemplary embodiment of the input device 30 of the present invention. In this embodiment, each of the object interfaces 330a-d comprises a hole having a particular shape. Each object interface is configured to connect to only one of the representation objects 340a-d, specifically the representation object having a similar shape. In the example of FIG. 3, the representation objects 340a-d represent streams of content corresponding to elements that can be placed in the sky of an outdoor scene of the presentation. The user may select to include the sun in the scene by placing representation object 340c into object interface 330c. In the embodiment shown in FIG. 3, each object interfaces 330 includes a socket, which enables data communication to each representation object 340. For example, when representation object 340c connected to object interface 330c, a plug-in component (not shown) of representation object 340c is inserted into socket 331c, through which data is communicated to and from the transmission object 300 to the representation object 340c.

As described above, however, the object interface 330c may not include a socket 331c. Instead, the object interface 330c may include a sensor, such as a pressure sensor at the bottom of the hole, which detects when an object has been fully inserted into the hole. Since only the representation object 340c has a shape that will enable it to be inserted into the hole, object interface 330c will know what type of representation object 340 has been inserted.

FIGS. 4A and 4B further illustrate how the output presentation can be affected by connection of a representation object 340 to transmission object 300. FIG. 4A shows a presentation being displayed on output device 15 corresponding to an image of an outdoor setting at night. Transmission object 300 includes an object interface 330 for receiving a representation object 340, which represents a stream of content associated with stars. FIG. 4B shows that, once the representation object 340 has been connected to the transmission object 300, the stream of content associated with stars is activated and the stars appear in the sky on output device 15.

It should be noted that the stream of content might not become active immediately after being activated by the end-user device 10. For example, if the image in FIG. 4A were to show a daytime image that included the sun in the sky, and the user were to insert the star-shaped representation object 340 into object interface 330, then the presentation may firs cause the sun to set and the sky to become dark, before the stars become active and are displayed. This example is illustrated in FIGS. 5A and 5B in connection with an exemplary embodiment in which the representation object 340 includes an indicator 341.

As illustrated in FIG. 2, data can be transmitted from the end-user device 10 to the transmission object 300. Therefore, when a stream of content does not immediately cause the stream to be output in the presentation, the end-user device 10 can be configured to notify the transmission object 300 when the stream of content is output. Such a notification can be transmitted from the end-user device 10 to the interface 320, which sends it to the microprocessor 310. The microprocessor 310 decodes the notification data and sends an indication command to the particular representation object 340 or object interface 330 corresponding to the stream currently being output. If an object interface 330 corresponds to the active stream, it relays the command to the connected representation object 340.

In response to receiving such an indication command, the representation object 340 will trigger its indicator 341 to output a visual or audible indication. The indicator 341 may comprise a light emitting diode (LED), a small light bulb, a buzzer, a music-playing device, a figurine that moves in a certain way when triggered, or any other device that is capable of signaling to the user that the corresponding stream is active.

FIG. 5A illustrates a situation where a stream of content (displaying of stars), which is represented by a representation object 340 connected to a transmission object, is not immediately active on the output device 15. The indicator does not produce any indication signal. Once the relevant stream is active, i.e., the stars are displayed (as shown in FIG. 5B); the indicator is triggered and outputs an indication signal to the user.

Even if there is no markings or clear resemblance that connects a representation object 340, or object interface 330, to a particular stream of content, the user can determine which indicator 341 is triggered by the appearance of a stream of content in the presentation. Therefore, the user will be able to deduce the relationship between the representation objects 340, or object interfaces 330, and the streams of content.

In another exemplary embodiment, as illustrated in FIG. 6, each representation object 340 includes a representation of the stream of content that it represents. This representation may visually resemble the stream of content, or emit a sound that is normally associated with the stream of content. FIG. 6 shows three representation objects 340a-c, each including a figurine that visually resembles its associated stream of content. Representation objects 340a, 340b, and 340c represent streams corresponding to a fish, tree, and boat, respectively. As shown in FIG. 6, representation objects 340a and 340b are connected to the transmission object, and a fish and tree are displayed on the output device 15. In an embodiment where the representation is audible, a representation object may emit a ‘moo’ sound if it represents a stream corresponding to a cow. It should be noted that FIG. 6 shows an embodiment where each representation object 340a-c can fit into any object interface 330. In this embodiment, identification data transmitted from the representation object 340 through the object interface 330 allows for the microprocessor to identify the representation object 340.

In another exemplary embodiment, an object interface 330 includes a visual or audible representation of a stream of content that it represents. For example, a picture may be printed next to the object interface 330, or a sound may be emitted from the object interface 330, that resembles or is logically connected to the represented stream.

In an exemplary embodiment, the end-user device 10 will cause instructions to be output to the user that indicate which representation object 340 or which object interface 330 represents each stream of content. For example, the output device 15 may output a visual or audio message that tells the user that placing a star-shaped object 340a into the star-shaped hole 330b of the transmission object (as illustrated in FIG. 3) will cause the day-time image to be transformed into a nighttime image.

According to another exemplary embodiment, control data may be provided with the real-time streams of content received at the end-user device 10 that cause certain streams of content to be automatically activated or deactivated. This allows the creator(s) of the real-time streams of content to have some control over what streams of content are activated and deactivated. For example, the author(s) of a narrative has a certain amount of control as to how the plot unfolds by activating or deactivating certain streams of content according to control data within the transmitted real-time streams of content.

Streams of content are not limited to elements to be displayed in a picture. As described above, an exemplary embodiment of the present invention is directed to an end-user device that transforms real-time streams of content into a narrative that is presented to the user through output device 15. The activation or deactivation of these streams may significantly affect the outcome of the narrative.

One possible implementation of this embodiment is an interactive television system. The end-user device 10 can be implemented as a set-top box, and the output device 15 is the television set. The process by which a user interacts with such a system is described below in connection with the flowchart 100 of FIG. 7.

In step 110, the end-user device 10 receives a stream of data corresponding to a new scene of a narrative and immediately processes the stream of data to extract scene data. Each narrative presentation includes a series of scenes. Each scene comprises a setting in which some type of action takes place. Further, each scene has multiple streams of content associated therewith, where each stream of content introduces an element that affects the plot.

For example, activation of a stream of content may cause a character to perform a certain action (e.g., a prince starts walking in a certain direction), cause an event to occur that affects the setting (e.g., thunderstorm, earthquake), or introduce a new character to the story (e.g., frog). Conversely, deactivation of a stream of content may cause a character to stop performing a certain action (e.g., prince stops walking), terminate an event (e.g., thunderstorm or earthquake ends), or cause a character to depart from the presentation (e.g. frog hops away).

The activation or deactivation of a stream of content may also change an internal property or characteristic of an object in the presentation. For example, activation of a particular stream may cause the mood of a character, such as the prince, to change from happy to sad. Such a change may become evident immediately, or may not be apparent until later in the presentation. Such internal changes are not limited to characters, and may apply to any object that is part of the presentation, which contains some characteristic or parameter that can be changed.

In step 120, the set-top box decodes the extracted scene data. The setting is displayed on a television screen, along with some indication to the user that he or she must determine how the story proceeds by manipulating the input device 30. This step may also present instructions that indicate to the user the streams of content with which each representation object 340 or object interface 330 is associated. Next, the user connects one or more representation objects into the object interfaces 330 of the transmission object 300, as shown in step 130.

In step 140, each object interface 330 that has been connected to a representation object 340 sends a signal identifying either itself or the connected representation object 340 to the microprocessor 320, which transmits this information to the set-top box. In step 150, the set-top box determines the streams of content that are linked to the identified representation objects 340 or object interfaces 330, and subsequently activates or deactivates the determined streams. Therefore, according to the user's interaction with the input device 30, one or more different actions or events may occur in the narrative presentation.

In step 160, the new storyline is played out on the television according to the activated/deactivated streams of content. In this particular example, each stream of content is an MPEG file, which is played on the television while activated.

The set-top box determines whether the activated streams of content necessarily cause the storyline to progress to a new scene in step 170. If so, the process returns to step 110 to receive the streams of content corresponding to the new scene. However, if a new scene is not necessitated by the storyline, the set-top box determines whether the narrative has reached a suitable ending point in step 180. If this is not the case, the user is instructed to use the user interface 30 in order to activate or deactivate streams of content and thereby continue the story. The flowchart of FIG. 7 and the corresponding description above is meant to describe an exemplary embodiment, and is in no way limiting.

The present invention provides a system that has many uses in the developmental education of children. The present invention promotes creativity and development of communication skills by allowing children to express themselves by interacting with and adapting a presentation or narrative. Children will find the input device 30 of the present invention very intuitive for interacting with streams of content, because every manipulation of the input device 30, i.e., the adding and removing of elements, has a similar effect on the presentation, i.e., the adding (activation) and removing (deactivation) of elements (streams). The playful nature of the input device 30 further provides children with motivation to interact with the present invention.

In addition, the input device 30 of the present invention can help children learn associations and relationships between different concepts. For example, the appearance of the representation object 340 may have a logical relationship with a stream of content that is not immediately obvious to a user. However, the user discovers that a relationship exists when the stream is activated in the presentation and the indicator 341 on the representation object 340 is triggered. For example, by using a cloud-shaped object to represent a rainstorm in a presentation, the present invention can be used to teach children cause-effect relationships between clouds and rain.

It should be noted, however, that the input device 30 of the present invention is in no way limited in its use to children, nor is it limited to educational applications. The present invention provides an intuitive and stimulating interface to interact with many different kinds of presentations geared to users of all ages.

A user can have a variety of different types of interactions with the presentation using the input device 30 of the present invention. As mentioned above, the user may affect the outcome of a narrative presentation by causing characters to perform certain types actions or by initiating certain events that affect the setting and all of the characters therein, such as a natural disaster or a weather storm. The input device 30 can also be used to merely change details within the setting, such as changing the color of a building or the number of trees in a forest. However, the user is not limited to interacting with presentations that are narrative by nature. The input device 30 can be used to choose elements to be displayed in a picture, to determine the lyrics to be used in a song or poem, to take one's turn in a game, to interact with a computer simulation, or to perform any type of interaction that permits self-expression within a presentation.

Further, the present invention is not limited to associating only one representation object 340 or object interface 330 to one stream of content. In an exemplary embodiment, multiple representation objects 340 can be linked to one stream of content, which is activated when each representation object 340 is added to the transmission object 330. Similarly, multiple object interfaces 330 can be linked to one stream of content. For example, adding only a house object to a transmission object 300 may activate a stream that displays a house, and adding a snowflake object may activate a stream that displays snow. However, in this embodiment, if both the house object and the snowflake object are added to the transmission object, a stream may be activated that displays an igloo.

In another embodiment, one representation object 340 or object interface 330 can be linked to multiple streams of content. For example, a moon object may activate multiple streams of content relating to night, causing the presentation to output images of the moon and stars, sounds that resemble chirping of crickets, etc.

The present invention has been described with reference to the exemplary embodiments. As will be evident to those skilled in the art, various modifications of this invention can be made or followed in light of the foregoing disclosure without departing from the scope of the claims.

1. An input device for an interactive system that receives and transforms streams of content into a presentation to be output according to a manipulation of said input device, comprising:
at least one representation object being connectable to a transmission object;
a transmission object which detects connection of said at least one representation object to said transmission object and transmits a signal to said interactive system based on said detected at least one representation object.

2. The input device according to claim 1, wherein each representation object represents a stream of content.

3. The input device according to claim 2, wherein a stream of content represented by a representation object is activated in said presentation when the corresponding representation object is connected to the transmission object.

4. The input device according to claim 3, wherein each representation object includes an indicator which outputs an indication signal when the representation object is connected to the transmission object and the stream of content represented by the representation object is active in said presentation.

5. The input device according to claim 2, wherein a stream of content represented by a representation object is deactivated in said presentation when the corresponding representation object is disconnected from said transmission object.

6. The input device according to claim 1, wherein said transmission object includes a microprocessor for generating said signal, and wherein
said signal identifies each representation object being connected to said transmission object.

7. The input device according to claim 1, wherein said signal is transmitted to said interactive system via wireless signals.

8. The input device according to claim 1, wherein said presentation includes a narrative.

9. A process in a system for transforming streams of content into a presentation to be output, comprising:
detecting the connection of one or more representation objects on a transmission object;
identifying said one or more representation objects connected to said transmission object;
associating said identified one or more representation objects to one or more streams of content;
activating or deactivating said one or more associated streams of content in said presentation.

10. A system comprising:
an end-user device for receiving and transforming streams of content into a presentation;
an input device including one or more representation objects and a transmission object which detects connection of said one or more representation objects to said transmission object, and
an output device for outputting the presentation,
wherein said end-user device activates or deactivates streams of content in said presentation based on the detected connection of representation objects to said transmission object.
